(19) United States
(12) Patent Application Publication
(10) Pub. No.: US 2015/0341416 A1
(43) Pub. Date: Nov. 26, 2015

(54) CLOUD MANAGEMENT SYSTEMS AND METHODS FOR EXECUTING APPLICATIONS OF ANDROID SYSTEMS

(71) Applicant: NATIONAL TSING HUA UNIVERSITY, Hsinchu (TW)

(72) Inventors: Yeh-Ching CHUNG, Hsinchu (TW); Jiun-Hung DING, Hsinchu (TW)

(21) Appl. No.: 14/613,314

(22) Filed: Feb. 3, 2015

(30) Foreign Application Priority Data
May 21, 2014 (TW) 103117725

(51) Int. Cl. H04L 29/08; G06F 3/0484; H04L 29/06

(52) U.S. Cl. CPC H04L 67/025; H04L 63/12; H04L 67/10; G06F 3/04847; G06F 3/04842

(57) ABSTRACT

A cloud management system for executing applications of Android system includes at least one user device and a cloud simulator. The cloud simulator couples to the user device via a network and is arranged for receiving a request from the user device, providing a first virtual phone interface corresponding to the user device to the user device in response to the request, wherein the first virtual phone interface includes respective applications of Android system, receiving an application selection from the user device and performing a first application corresponding to the application selection and returning the execution result for the first application to the user device for displaying via the first virtual phone interface.

### CROSS REFERENCE TO RELATED APPLICATIONS

This application claims the benefit of Taiwan Patent Application No. 103117725, filed May 21, 2014, the entirety of which is incorporated by reference herein.

### BACKGROUND OF THE INVENTION

1. Field of the Invention

The disclosure relates generally to cloud management systems and methods and, more particularly to cloud management systems and methods for executing applications of an Android system.

2. Description of the Related Art

Recently, portable devices such as handheld devices have become more and more technically advanced and multifunctional. For example, a handheld device may receive email messages, have an advanced contact management application, allow media playback, and have various other functions. Because of the conveniences of devices with multiple functions, the devices have become necessities of life.

Mobile devices may be provided with multiple applications (apps) or services for users to control the functions thereof, and these applications Apps or services are applied to a Google™ Android System. Android system can be viewed as an operating system platform that is specially designed for portable devices such as smartphones, and portable devices that are installed with an Android system may control the functions or execute specific operations of the portable device through the applications Apps developed for Android system. Applications APPs which can be applied to the Android system are developed using an Android simulator. Conventional Android simulators are designed for developers to develop Android-based applications APPs, thus, prior to use, Java environment must be established, and users must also be familiar with the related Android development environment and software development kit (SDK), all of which are considered very difficult and inconvenient for general users. Additionally, to users whose portable devices are not installed with the Android system, it is impossible to execute an Android App under a non-Android device.

### BRIEF SUMMARY OF THE INVENTION

Methods for executing applications of Android system and related cloud management systems are provided.

In an embodiment of a method for executing applications of Android system in a user device, a request is first transmitted to a cloud server via a web browser. A virtual phone interface corresponding to the request is then received from the cloud server and a webpage including the virtual phone interface is further displayed, wherein the virtual phone interface comprises respective applications of Android system. Then, an application selection is transmitted to the cloud simulator via the virtual phone interface. Thereafter, the execution result corresponding to the application selection is received from the cloud server and the received execution result is then displayed on the virtual phone interface.

In an embodiment of a method for executing applications of Android system in a cloud server, a request is first received from a first user device. A first virtual phone interface corresponding to the first user device is provided to the first user device in response to the request, wherein the first virtual phone interface comprises respective applications of Android system for the first user device. Thereafter, an application selection is received from the first user device and a first application corresponding to the application selection is executed and the execution result for the first application is returned to the first user device for displaying via the first virtual phone interface.

An embodiment of a cloud management system for executing applications of Android system includes at least one user device and a cloud simulator. The cloud simulator couples to the user device via a network and is arranged for receiving a request from the user device, providing a first virtual phone interface corresponding to the user device to the user device in response to the request, wherein the first virtual phone interface includes respective applications of Android system, receiving an application selection from the user device and performing a first application corresponding to the application selection and returning the execution result for the first application to the user device for displaying via the first virtual phone interface.

Methods for executing applications of Android system may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a cloud management system of the invention;

FIG. 2 is a schematic diagram illustrating an embodiment of a webpage of the invention;

FIG. 3 is a flowchart of an embodiment of a method for executing applications of Android system of the invention; and

FIG. 4 is a flowchart of another embodiment of a method for executing applications of Android system of the invention.

### DETAILED DESCRIPTION OF THE INVENTION

The following description shows several exemplary embodiments which carry out the invention. This description is made for the purpose of illustrating the general principles of the invention and should not be taken in a limiting sense. The scope of the invention is best determined by reference to the appended claims.

Embodiments of the invention provide cloud management systems and related methods for executing applications (Apps) of an Android system, which allow a user with a user device to operate an Android system with full functions on the web browser through the cloud simulator, thus providing an application APP software component trading platform and application APP software component online LiveDemo services.

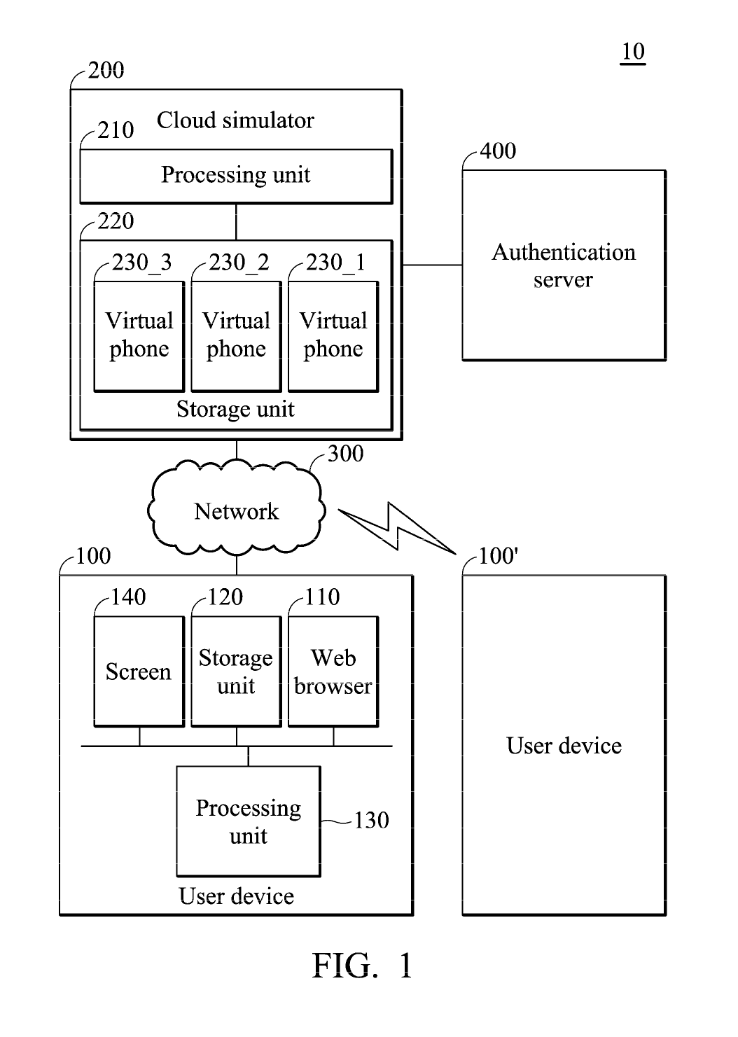

FIG. 1 is a schematic diagram illustrating an embodiment of a cloud management system for executing applications APPs of Android system of the invention. As shown in FIG. 1, the cloud management system 10 includes at least user devices 100 and 100′, a cloud simulator 200 and an authentication server 400. The user devices 100 and 100′ may be electronic device with the same type or electronic devices with different types, such as a computer system, a PDA (Personal Digital Assistant), a smartphone, a mobile phone, an MID (Mobile Internet Device, MID), a laptop computer, a car computer, a digital camera, a multi-media player, a gaming device, or any other type of mobile computational device, however it is to be understood that the invention is not limited thereto. In one embodiment, the user device 100 may be a device that is not installed with Android system or is not able to operate under Android system, such as a personal computer and the user device 100′ is a device that is already installed with Android system, such as an Android phone. The user devices 100 and 100′, the cloud simulator 200 and the authentication server 400 may mutually execute communication and transfer data via a network 300, such as WCDMA, 3G network, Internet or other wired/wireless network.

The user device 100 at least comprises a web browser 110, a storage unit 120 and a processing unit 130. The storage unit 120 may be a built-in memory, or an external memory card, which stores any type of data. The processing unit 130 which is coupled to the web browser 110 and the storage unit 120 can perform the method for executing applications of Android system of the present invention, which will be discussed further in the following paragraphs.

In one embodiment, the user device 100 can be an Android phone, which may further comprises a wireless communication unit (not shown) and a processing unit (not shown). The wireless communication unit may comprise a baseband unit (not shown) and a radio frequency (RF) unit (not shown). The baseband unit may contain multiple hardware components to perform baseband signal processing, including analog to digital conversion (ADC)/digital to analog conversion (DAC), gain adjusting, modulation/demodulation, encoding/decoding, and so on. The RF unit may receive RF wireless signals, convert the received RF wireless signals to baseband signals, which are processed by the baseband unit, or receive baseband signals from the baseband unit and convert the received baseband signals to RF wireless signals, which are later transmitted. The RF unit may also contain multiple hardware devices to perform radio frequency conversion. For example, the RF unit may comprise a mixer to multiply the baseband signals with a carrier oscillated in the radio frequency of the mobile communications system, wherein the radio frequency may be 900 MHz, 1900 MHz, or 2100 MHz utilized in WCDMA systems, or may be 900 MHz, 2100 MHz, or 2.6 GHz utilized in LTE systems, or others depending on the radio access technology (RAT) in use. The processing unit may further control the operation of the wireless communication unit and other functional components, such as a screen unit 140 and/or keypad serving as the MMI (man-machine interface), a storage unit storing the program codes of applications or communication protocols, or others.

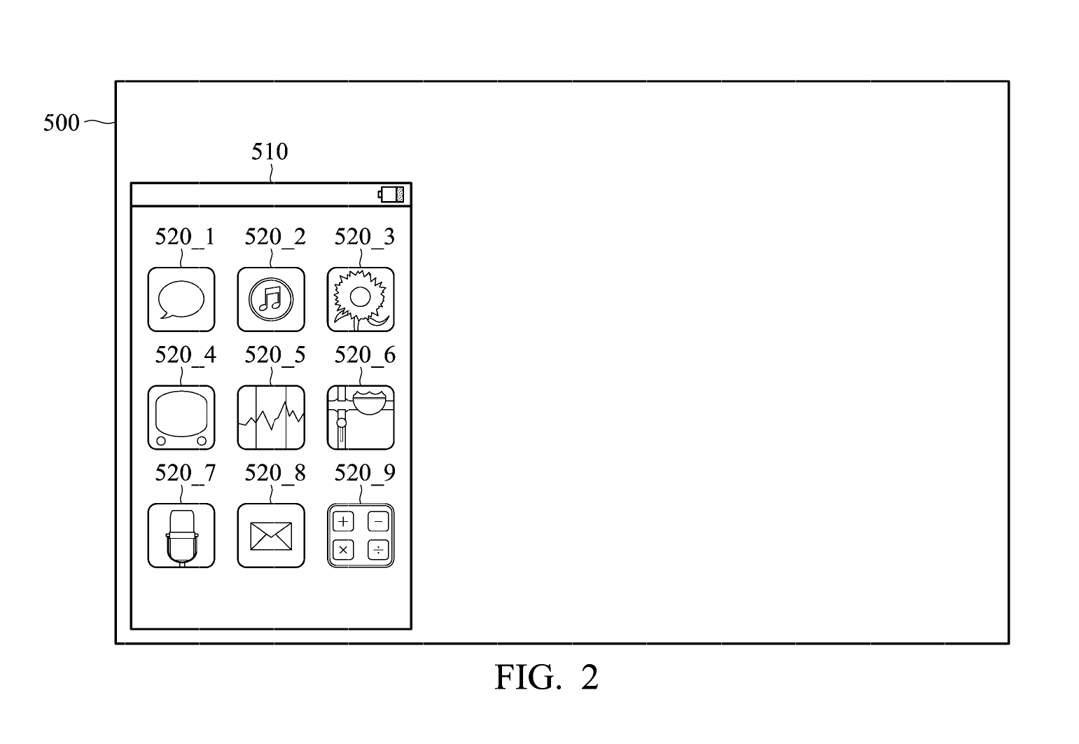

The user device 100 may further comprise a screen 140. The screen 140 can display related data, such as texts, figures, interfaces, and/or information. It is understood that, in some embodiments, the screen 140 may be integrated with a touch-sensitive device (not shown). The touch-sensitive device has a touch-sensitive surface comprising sensors in at least one dimension to detect contact and movement of at least one object (input tool), such as a pen/stylus or finger near or on the touch-sensitive surface. Accordingly, users are able to input commands or signals via the screen. For example, when the screen 140 is a touch screen integrated with a touch-sensitive device, the user may perform various operations, such as clicking an APP icon displayed in the virtual phone interface, under the displayed virtual phone user interface directly as though using an actual phone, and transmit a request for executing a first APP corresponding to the APP icon to the cloud simulator, and the cloud simulator may execute this first APP in response to the request, and reply with or return the corresponding execution results to the user device based on the user input. The web browser 110 may generate the corresponding webpage, which includes a virtual phone interface 510. FIG. 2 is a schematic diagram illustrating an embodiment of a webpage of the invention. As shown in FIG. 2, the webpage 500, which includes a virtual phone interface 510 that displays icons 520_1˜520_9 of all operable Applications APPs APP1-APP9, wherein the virtual phone interface 510 allows the user to click or select icons 520_1˜520_9 to select any of the Applications APPs APP1-APP9 for execution. For example, user may through clicking of the icon 520_1 to indicate that execution of the APP APP1 is desired. Thereafter, after the cloud simulator 200 returns the execution results of APP APP1, the virtual phone interface 510 will display the screen for the corresponding execution results. In some embodiments, the virtual phone interface 510 also provides functions that are similar to current cellular phones, such as dial keys, communications software, communications modules, etc. that are used to execute corresponding functions, such as dialing a call, sending messages, wireless transmission and so on.

The cloud simulator 200 may comprise a processing unit 210 and a storage unit 220. In one embodiment, the cloud simulator 200 is a multi-core parallel processing simulator with cloud computing. The cloud simulator 200 may connect to the user device 100 via the network 300, and thus may transmit data to or receive data from the user device 100 via the network 300. The cloud simulator 200 may also include identification information (e.g. MAC/IMEI/IP information and so on) of multiple user devices 100 and their authentication information to be used for identifying the identity of the user of the user device 100. The storage unit 220 of the cloud simulator 200 is capable of providing a number of virtual phones 230_1˜230_3, and each virtual phone may have a customized virtual phone user interface. The processing unit 210 of the cloud simulator 200 can provide a corresponding virtual phone based on the authenticated identity of the user. The processing unit 210 which is coupled to the storage unit 220 can perform the method for executing applications of Android system of the present invention, which will be discussed further in the following paragraphs. The authentication server 400 which is coupled to the cloud simulator 200 can execute an authentication procedure to identify the identity of the user of the user device 100 and a security determination procedure to determine the security of the data.

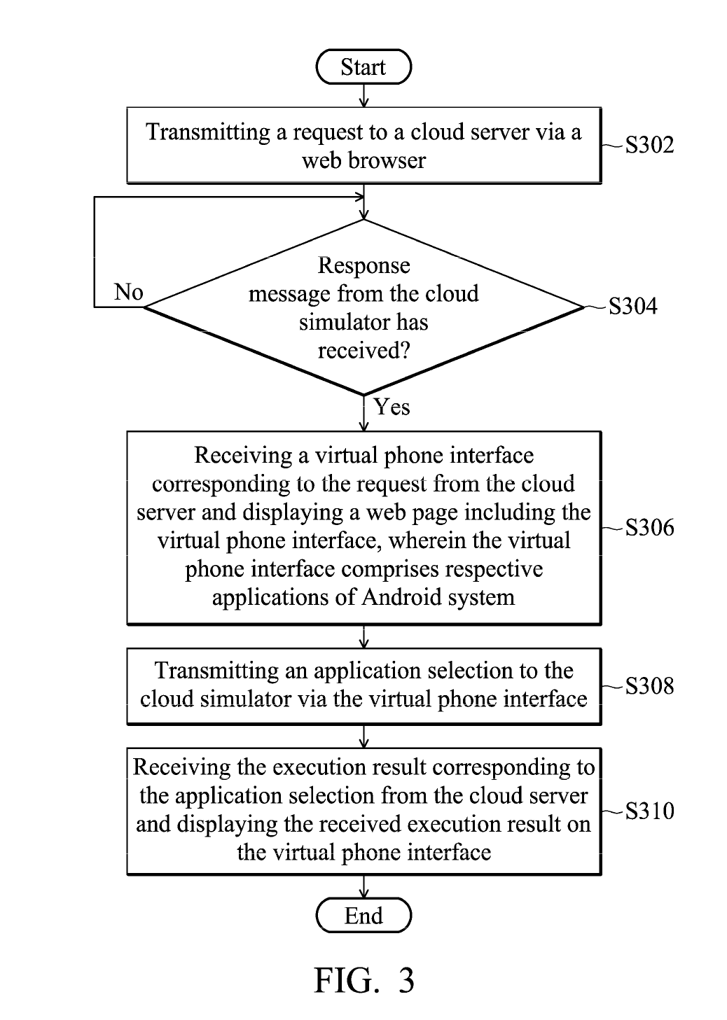

FIG. 3 is a flowchart of an embodiment of a method for executing applications of Android system of the invention. Please refer to FIGS. 1 and 3. The method for executing applications of Android system can be applied to a user device. For example, the user device can be the user device 100 as shown in FIG. 1, such as a personal computer or a handheld device, e.g. a PDA, a smartphone, a mobile phone, an MID, a laptop computer, a tablet computer, or any other type of handheld device. However, it is to be understood that the invention is not limited thereto. In some embodiments, the user device can be an Android phone that is already installed with the Android system. In some embodiments, the user device can be a device that is not installed with the Android system or cannot execute Android system App. It is to be noted that, in this embodiment, the user device 100 is already connected to the cloud simulator 200 via the network 300, and therefore it may transmit data to the cloud simulator 200 via the network 300 or receive data from the cloud simulator 200 via the network 300. The cloud simulator 200 may also include identification information (e.g. MAC/IMEI/IP information and so on) of multiple user devices 100 and their authentication information to be used for identifying the identity of the user of each user device 100.

First, when a user of the user device 100 wishes to operate or browse the contents of the virtual phone, in step S302, the user device 100 may activate the web browser 110 and transmit a request to the cloud simulator 200 via the web browser 110. Upon sending of request, the user device 100 will standby to receive a reply from the cloud simulator 200. In this embodiment, the reply of the cloud simulator 200 may include corresponding virtual phone interface information.

Upon receiving the request from the user device 100, the cloud simulator 200 may first perform authentication to the user device 100, to confirm whether the user is a legal user or is an authenticated user, and when the authentication is completed, based on the authentication information, find out from its database, or generate the corresponding virtual phone and its virtual phone interface, wherein the virtual phone interface includes the corresponding multiple Applications APPs of Android system. After finding the virtual phone interface, the cloud simulator 200 will transmit the response message including the corresponding virtual phone interface information back to user device 100. To be more specific, the request may include authentication information, for example but not limited to, the user account and password or device identification code and so on. The cloud simulator 200 may obtain the authentication information from the request and identify the identity of the user of the user device 100 based on the authentication information in the request, so at to determine the corresponding virtual phone interface.

After the user device 100 has passed the authentication, i.e. after finding out the virtual phone interface, the cloud simulator 200 transmits the response message which includes the corresponding virtual phone interface information back to user device 100. Hence, in step S304, the user device 100 receives a virtual phone interface corresponding to the request from the cloud simulator 200 and displays a webpage which includes virtual phone interface (such as the webpage 400 of FIG. 2), wherein the virtual phone interface includes the corresponding applications APPs of the Android system. User may perform various operations on the applications APPs of the Android system in the virtual phone interface.

Thereafter, user may either click or move the cursor to select a first APP within the virtual phone interface to input an app selection, and thus, in step S306, the user device 100 receives and transmits an application selection to the cloud simulator 200 through the virtual phone interface. For example, referring to FIG. 2, if the user wishes to execute the application 401, the user may click on the application 401 in the virtual phone interface to select the application 401 of the virtual phone interface, and then the user device 100 receives and transmits an application selection related to the application 401 to the cloud simulator 200 through the virtual phone interface.

When the cloud simulator 200 receives an application selection that is related to the application 401, it will know to execute the application 401, and hence will activate and execute the application 401, and then return the execution results for the application 401 back to the user device 100.

Next, in step S308, the user device 100 receives an execution result corresponding to the application selection (i.e. the execution result for the application 401) from the cloud simulator 200 and then displays the execution result corresponding to the application selection on the virtual phone interface. Therefore, on the virtual phone interface, the screen will switch to the execution result screen, so that the user may view and simulate various execution results of the selected application through interactions.

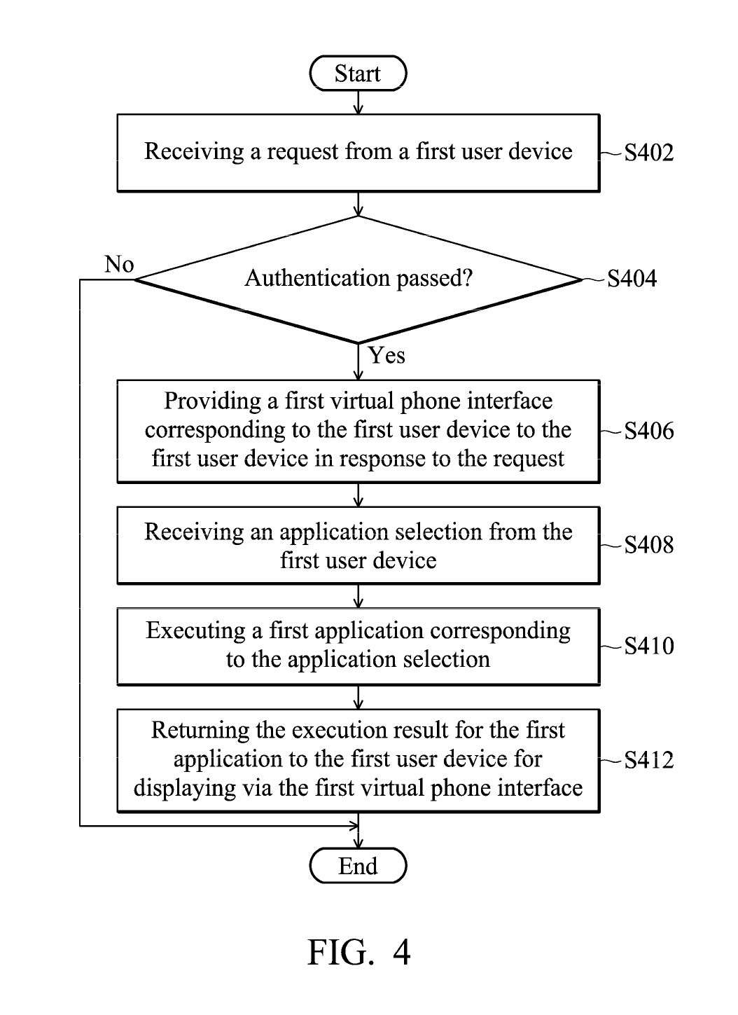

FIG. 4 is a flowchart of another embodiment of a method for executing applications of Android system of the invention. Please refer to FIGS. 1 and 4. The method for executing applications of Android system can be applied to a cloud simulator. For example, the cloud simulator can be the cloud simulator 200 as shown in FIG. 1 and the cloud simulator 200 is a multi-core parallel processing simulator with cloud computing, which is capable of executing or simulating applications applied to the Android system. It is to be noted that, in this embodiment, the cloud simulator 200 is already connected to the user device 100 via the network 300, and therefore it may transmit data to the user device 100 via the network 300 or receive data from the user device 100 via the network 300. The cloud simulator 200 may also include identification information (e.g. MAC/IMEI/IP information and so on) of multiple user devices 100 and their authentication information to be used for identifying the identity of the user of each user device 100. In this embodiment, the cloud simulator 200 is capable of providing multiple virtual phones, and each virtual phone may have a customized virtual phone user interface and the cloud simulator 200 can provide a corresponding virtual phone for each user based on the authenticated identity of the user.

First, when a user of the first user device 100 wishes to operate or browse the contents of the virtual phone, the first user device 100 may activate the web browser 110 and transmit a request to the cloud simulator 200 via the web browser 110. Thus, the cloud simulator 200 receives a request from the first user device 100 (step S402). Then, the cloud simulator 200 performs authentication to the first user device 100 and determines whether the authentication is passed (step S404). In this embodiment, the request transmitted by the first user device 100 may further include authentication information, for example but not limited to, the user account and password or device identification code and so on, and the cloud simulator 200 may obtain the authentication information from the request and perform an authentication procedure to identify the identity of the user of the first user device 100 based on the authentication information in the request, so at to obtain the corresponding virtual phone interface. To be more specific, the cloud simulator 200 may first perform authentication to the first user device 100, to confirm whether the user is a legal user or is an authenticated user. In one embodiment, the authentication procedure can be performed by the cloud simulator 200 directly. In another embodiment, the authentication procedure can be performed by an authentication server (e.g. the authentication server 400 of FIG. 1). In this case, the cloud simulator 200 will first transmit the authentication information to the authentication server for performing the authentication procedure and the authentication server will send back the authenticated result to the cloud server 200 after the authentication procedure is completed. When the authentication is failed (No in step S404), that is, the user of the first user device 100 is an illegal user or an unauthorized user, the cloud server 200 replies a reject message to the first user device 100 to reject the request and the procedure ends. When the authentication is passed (Yes in step S404), that is, the user of the first user device 100 is a legal user or an authorized user, the cloud server 200 provides a first virtual phone interface corresponding to the first user device 100 to the first user device 100 in response to the received request (step S406). Note that the virtual phone interface includes the corresponding multiple applications APPs of Android system. For example, the cloud simulator 200 may find out from the virtual phone files stored in its database, or generate the virtual phone corresponding to the authentication information (e.g. the user account) and its virtual phone interface based on the authentication information. After finding the virtual phone interface, the cloud simulator 200 will transmit the response message including the corresponding virtual phone interface information back to the first user device 100.

Accordingly, the first user device 100 receives a first virtual phone interface corresponding to the request from the cloud simulator 200 and displays a webpage which includes the virtual phone interface (such as the webpage 400 of FIG. 2).

Thereafter, user may either click or move the cursor to select a first app within the virtual phone interface to input an application selection, and thus, the first user device 100 transmits an application selection to the cloud simulator 200 through the virtual phone interface.

Upon receiving the application selection from the first user device 100 (step S408), the cloud simulator 200 executes a first application corresponding to the application selection (step S410) and returns the execution result for the first application to the first user device 100 for displaying via the virtual phone interface (step S412). For example, referring to FIG. 2, if the user wishes to execute the application 401, the user may click on the application 401 in the virtual phone interface to select the application 401 of the virtual phone interface, and when the cloud simulator 200 receives an application selection that is related to the application 401, it will know to execute the application 401, and hence will activate and execute application 401, and then return the execution results for the application 401 back to the first user device 100. Thereafter, the first user device 100 can display the execution result corresponding to the application selection on the virtual phone interface. Therefore, on the virtual phone interface, the screen will switch to the execution result screen, so that the user may view and simulate various execution results of the selected application through interactions. The cloud simulator 200 then provides various execution results for the selected application to the first user device 100 according to the user interaction.

As mentioned above, the cloud simulator 200 is capable of providing multiple virtual phones, and each virtual phone may have a customized virtual phone user interface and the cloud simulator 200 will provide a corresponding virtual phone based on the authenticated identity of the user.

Therefore, in some embodiments, the cloud simulator 200 may further receive a request from a second user device (e.g. the user device 100′ of FIG. 1), and corresponding to the request, provide to the second user device a second virtual phone interface corresponding to the second user device, wherein the second virtual phone interface includes corresponding applications APPs of the Android system and the second virtual phone interface is different from the first virtual phone interface. For example, the user identity of the first user device may be an employee and thus the first virtual phone interface will only display the general application group and will only allow restricted read and write to their data; whereas the user identity of the second user device may be an administrator, such as a manager, and therefore, the second virtual phone interface will not only display the general application group but will also display the application group with administrative functions and may perform unrestricted read and write to their data. By doing so, the goal of data security, protection and effective control can be achieved.

In some embodiments, the cloud simulator 200 is capable of providing a public cloud service, and may provide general user also known as public user with multiple pre-setup virtual phones, the virtual phone interface of which will display operation interfaces of executable preset applications APPs, and based on requirements, the user may make request to the cloud simulator 200 for using a specific virtual phone and perform various operations on that virtual phone, enabling more usage convenience for the user.

In some embodiments, the cloud simulator 200 is capable of providing a private cloud service, allowing corporate accounts or groups to have multiple dedicated virtual phones and each virtual phone may display a virtual phone interface with the same preset operation interface or it may display virtual phone interface with operation interface of different applications APPs and assign different authorizations such as read/write authorization based on the user identity, thereby achieving the goal of data security, protection and effective control.

In some embodiments, when receiving any data from the user device, the cloud simulator 200 may first transmit the data to the authentication server authentication server 400 to perform a security determination procedure and based on the determination results of the security determination procedure to determine whether the data is secure, so as to avoid illegal data from infiltrating the cloud management system.

In some embodiments, the cloud simulator 200 of the present invention may further provide an online applications APPs trading platform, and may operate full Android system with full functions on the web browser 110 of the user device 100 through the cloud simulator 200, thereby providing an application software component trading platform of Android system and application software component online LiveDemo services. For example, application software component developers may pay to publicize their developed APP components through the provided platform. Thereafter, application implementation developers may through the platform, search, perform trails and purchase the publicized APP components, and prior to the purchase selection of an APP software component, they may through cloud simulator 200 perform online LiveDemo, so as to confirm whether that APP software component meets their requirements before making the actual purchase, achieving the goals for APP software component online testing and online trading.

Therefore, the cloud management systems and related methods for executing applications of Android system of the invention can provide a virtual phone interface on a webpage via the web browser, to operate a cloud virtual phone, so as to provide a web-based Android system simulator, allowing the user from a local port, to display and operate the applications of Android system provided by cloud or to determine which application to operate via the operation interface of the virtual phone in the cloud, thereby achieving the goals of data security, protection and effective control. Moreover, the cloud management systems and related methods for executing applications of Android system of the invention can allow corporate accounts to display specific virtual phone interface with the operation interface of different application configurations and assign different authorizations based on the user identity, achieving the goals of data security, protection and effective control. Furthermore, the present invention can further provide a type of online applications APPs trading platform, that could operate full Android system on the web browser through the cloud simulator, and subsequently, provide an application software component trading platform and application software online LiveDemo services, thus achieving the goals of application APP software component online testing and online trading and further enhancing the development of APP applications industries.

Methods for executing applications of Android system, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application-specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A method for executing applications of Android system in a user device, comprising:
transmitting a request to a cloud server via a web browser;
receiving a virtual phone interface corresponding to the request from the cloud server and displaying a webpage including the virtual phone interface, wherein the virtual phone interface comprises respective applications of Android system;
transmitting an application selection to the cloud simulator via the virtual phone interface; and
receiving the execution result corresponding to the application selection from the cloud server and displaying the received execution result on the virtual phone interface.

2. The method of claim 1, wherein the user device is a device that is installed with the Android system.

3. The method of claim 1, wherein the user device is a device that is not installed with the Android system or cannot execute the applications of the Android system.

4. A method for executing applications of Android system in a cloud server, comprising:
receiving a request from a first user device;
providing a first virtual phone interface corresponding to the first user device to the first user device in response to the request, wherein the first virtual phone interface comprises respective applications of Android system for the first user device;
receiving an application selection from the first user device; and
performing a first application corresponding to the application selection and returning the execution result for the first application to the first user device for displaying via the first virtual phone interface.

5. The method of claim 4, further comprising:
receiving a request from a second user device; and
providing a second virtual phone interface corresponding to the second user device to the second user device in response to the request, wherein the second virtual phone interface comprises respective applications of Android system for the second and is different from the first virtual phone interface.

6. The method of claim 4, wherein the cloud simulator further provides an application software component trading platform and application software online LiveDemo services.

7. A cloud management system for executing applications of Android system, comprising:
at least one user device; and
a cloud simulator coupled to the user device via a network, receiving a request from the user device, providing a first virtual phone interface corresponding to the user device to the user device in response to the request, wherein the first virtual phone interface comprises respective applications of Android system of the user device, receiving an application selection from the user device and performing a first application corresponding to the application selection and returning the execution result for the first application to the user device for displaying via the first virtual phone interface.

8. The cloud management system of claim 7, further comprising:
an authentication server coupled to the cloud simulator, wherein the cloud simulator further receives data from the user device, transmits the data to the authentication server for data authentication and executes the data only after the data authentication is passed.

9. The cloud management system of claim 7, wherein the user device is a device that is installed with the Android system.

10. The cloud management system of claim 7, wherein the user device is a device that is not installed with the Android system or cannot execute the applications of the Android system.

11. The cloud management system of claim 7, wherein the cloud simulator further provides an application software component trading platform and application software online LiveDemo services.
